(19) United States
(12) Patent Application Publication
(10) Pub. No.: US 2003/0198290 A1
(43) Pub. Date: Oct. 23, 2003

(54) Image encoding system

(75) Inventors: Andrew Millin, Santa Monica, CA (US); Philip Victor Harman, Scarborough (AU)

Correspondence Address: BANNER & WITCOFF, 1001 G STREET N W, SUITE 1100, WASHINGTON, DC, 20001, US

(73) Assignee: Dynamic Digital Depth Pty.Ltd., Bentley (AU)

(21) Appl. No.: 10/125,565

(22) Filed: Apr. 19, 2002

(51) Int. Cl. H04N 7/12

(52) U.S. Cl. 375/240.01

(57) ABSTRACT

A method of encoding a 2D image with an associated depth map, said 2D image having a plurality of frames making up the 2D image and each frame having a odd and even field, wherein the method includes the step of recording the associated depth map in at least a portion of the odd or even field.

### FIELD OF THE INVENTION

The present invention is generally directed towards the display of stereoscopic images. In particular the invention is designed to enable the recording, storage and playback of 2D video images and an associate depth map on standard video media.

### BACKGROUND OF THE INVENTION

Glasses free, or autostereoscopic, 3D display devices are becoming increasingly popular due to the enhanced visual perception stereoscopic visualization provides.

Autostereoscopic display systems are available from a number of manufacturers including 4D-Vision, Sharp, Stereographics, Dimension Technologies and Philips.

Whilst some of these displays require a left and right eye image in order to operate others require additional views ranging from eight to twelve.

The present Applicants have previously disclosed in PCT/AU98/01005, hereby incorporated by reference in full, how a 2D image and associated depth map can be used to synthesize a number of perspective views from the 2D image. Such synthesized images may be used to drive autostereoscopic displays that require two, or more, images.

This prior disclosure also disclosed how such depth maps could be compressed and imbedded in the VOB of a DVD. This enabled the playing of such a depth map encoded DVD on a standard DVD player in 2D. As such the DVD was described as being “2D compatible” since a standard DVD player would decode the 2D image and ignore the additional depth data in the VOB.

The prior disclosure also described how a proprietary DVD player could be constructed that would extract the compressed depth map from the VOB, decompress it and combine it with the 2D image to form stereo images.

It will be appreciated that a special DVD player is required in order to implement this prior disclosure. It will also be appreciated that the advantage of this previous invention is that a depth map encoded DVD may be played in 2D on a standard DVD player and that such encoding will cause no degradation of the 2D image.

It has been found that a number of applications exist for autostereoscopic screens, driven from a 2D plus depth map source, where 2D compatibility is not necessary and it is these applications that this current invention addresses.

### OBJECT OF THE INVENTION

It is the object of this invention to disclose a technique that enables a 2D image and associated depth map to be simultaneously recorded, stored and replayed on standard video media.

### SUMMARY OF THE INVENTION

With the above object in mind the present invention provides in one aspect a method of encoding a 2D image with an associated depth map, said 2D image having a plurality of frames making up said 2D image and each frame having a odd and even field, wherein said method includes the step of recording said associated depth map in at least a portion of said odd or even field.

The depth map may be recorded in either the odd or even field of each frame. In this way, the original 2D image is transmitted in one field, and the depth data transmitted in the other field. Transmitting of image data in only one field will lead to loss of the data which would normally be transmitted in the other field. In this circumstance, and were necessary, the available data may be used to interpolate for the missing data. That is, if the odd field is replaced with depth data, then the odd lines of the image may be interpolated from the even lines which have been transmitted in the even field.

As an alternative to transmitting the depth map in one entire field, a portion of each or one of the fields may be used to transmit the depth map. In this way a predetermined proportion or number of lines in each or one of the fields may be set aside for the depth map. Further, as the depth map does not require chrominance data, then the chrominance channel may be utilized for further depth map information. In this way, the proportion or number of lines required to transmit the depth map data may be further reduced.

In a further aspect, the present invention provides a image including at least one frame, said frame including an odd field and an even field, wherein an associated depth map is recorded in at least a portion of said odd and/or even field.

The invention discloses techniques for simultaneously recording a 2D image and associated depth map onto video media. The technique enables standard video recording and playback processes and equipment to be used to record, store and playback such composite images.

The invention also overcomes artifacts that would otherwise be generated as a byproduct of video compression techniques used to format such 2D plus depth video images onto standard video media.

### BRIEF DESCRIPTION OF THE DRAWINGS

FIG. 1 shows the format of a video signal.

FIG. 2 shows the storage of a 2D image and a depth map in a video signal in a preferred embodiment of the present invention.

FIG. 3 shows an alternative method of storing a 2D image and a depth map in a video signal. In accordance with the present invention.

### DESCRIPTION OF PREFERRED EMBODIMENT

The present invention enables the simultaneous recording and storage of a 2D image and associated depth map onto standard video media.

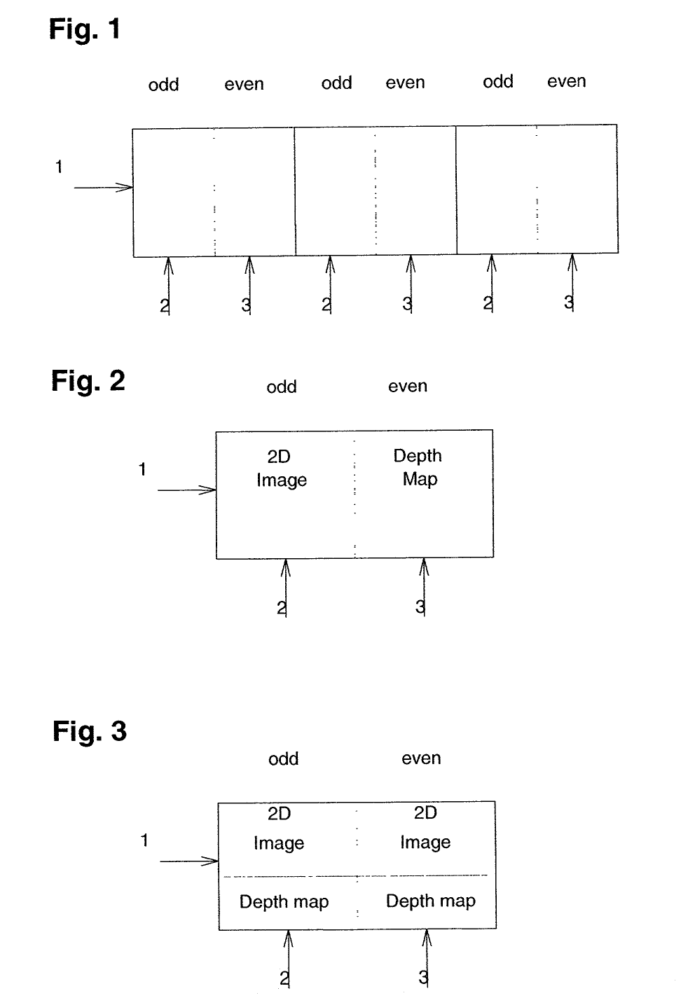

Analogue or 2D video images are commonly formatted in frames. In FIG. 1, three frames of a video signal are shown as 1. The time taken for each frame is dependent upon the video standard in use but is approximately 1/30 second for NTSC and 1/25 second for PAL.

Each frame is separated into two fields called the odd 2, and even 3, field, as shown in FIG. 1.

For an NTSC video signal the odd field contains lines 1, 3, 5 . . . 525 of an image and the even field contains lines 2, 4, 6 . . . 524 of the image. This technique is known to those skilled in the art as interlacing.

Conventional practice and existing techniques and systems require a 2D image to be broken up into both the odd and even fields, and for both these fields to then be transmitted to a display means so that the full image data can be properly shown. The present invention differs significantly from this practice in that at least a predetermined number of lines in one or both of the fields is used to transmit depth map data as opposed to the original 2 dimensional image. That is, the image data is replaced with the depth map data.

In one embodiment this invention specifically discloses that when analogue (e.g. NTSC and PAL) recordings of 2D images and associated depth maps are required the odd field may be used to record the 2D image and the even field the associated depth map. The opposite of this may also be used, namely that the even field may be used to record the 2D image and the odd field the associated depth map. This arrangement is illustrated in FIG. 2.

Accordingly one embodiment of this invention stores a 2D image and associated depth map in the odd and even fields of an analogue video signal.

The advantage of this technique is that it is simple to implement and is compatible with current video recording, processing and playback equipment. Those skilled in the art will also be aware of techniques to extract the 2D image and depth map from the video image on play back and process these into two or more stereo images as described for example in PCT/AU98/01005.

It will be appreciated that this technique results in the 2D image and depth map having a vertical resolution of half a conventional video image. For example, assuming NTSC encoding of the video signal, the normal vertical resolution of the video signal would be approximately 525 lines but in this case it will be half the number of lines.

Where necessary the apparent resolution of the image may be restored by the use of line doubling techniques as described in PCT/AU00/00673. Alternatively other line doubling techniques may be implemented, for example conventional averaging techniques. What is necessary is that the missing line data may be interpolated from the available data. For example, if only the odd field of the 2D image is transmitted, then the even lines may be interpolated from the odd lines which were transmitted with the odd field. That is, lines 1 and 3 may be processed to determine line 2. It will be appreciated that such techniques can be applied to both the 2D image and depth map if necessary.

In general, for the simulation of two or more images for use with autostereoscopic display systems, the resolution of the depth map may be less than that of its associated 2D image. Experimentation has shown that the depth map may be reduced to less than half the horizontal and vertical resolution of the associated 2D image before the viewer notices a degradation in stereoscopic effect.

Since the depth map may have lower resolution than the 2D image, additional resolution can be assigned for use by the 2D image.

For example, the 2D image may be contained in ⅔ of a field and the depth map the remaining ⅓. This is illustrated in FIG. 3. The use of ⅔ and ⅓ is for explanation purposes only and is not intended to limit the scope of the invention in any manner. As another alternative, the 2D image may be transmitted in the odd field, and also half of the even fields. The other half of the even field may then be used to transmit the depth map data. In this way, the number of lines which may be required to be interpolated can be reduced.

Accordingly, an alternative embodiment of this invention is to store a 2D image in a fraction n of the lines of a video image and the associated depth map in the remaining fraction (1-n).

It will also be appreciated that the depth map, as well as being of lower resolution than its associated 2D image, typically contains luminance information only since it represents a gray scale image.

Since only luminance information is required there is no information contained in the chrominance channel of the video signal during the fraction (1-n). This spare capacity can be used to carry additional information.

The ratio of lines used to carry 2D video images, and that used for depth maps, can thus be altered by including depth information in the chrominance channel. For example, given that DVD compatible MPEG2 encodes YUV at a resolution of 4:2:0 the two half resolution chrominance channels can be used to double the amount of depth data contained in a single frame.

As an example consider the use of ⅚^{th} of the lines of one field to carry the 2D image and the remaining ⅙ of the lines used to carry the depth map. During the ⅙0 of the image where the depth map is recorded additional depth map information may be recorded in the chrominance channel. Alternatively, rather than considering the use of the chrominance channel can be used to increase the amount of depth data contained in a single frame, it may be considered that the use of the chrominance channel to carry depth data reduces the fraction (1-n) of lines necessary to transfer the depth data.

The use of ⅚ and ⅙ is for explanation purposes only and is not intended to limit the scope of the invention in any manner.

It will be appreciated by those skilled in the art that the luminance and chrominance signals may be processed separately, in order to recover the depth data, and that S-Video is a well known standard for the separate processing of these two signals.

Hence one embodiment of this invention to store a 2D image in a fraction n of the lines of a video image and records an associated depth map in the remaining fraction (1-n), where a percentage m of the depth map resolution is stored in the luminance component of the (1-n) fraction of lines, and the remaining (1-m) percentage of the depth map resolution is stored in the chrominance component of the (1-n) fraction of lines.

Whilst the above techniques should be relatively simple to implement in an analogue NTSC or PAL system, additional factors should be considered when digital video compression techniques, such as MPEG, are applied to the 2D plus depth map signal.

In particular, the technique whereby the 2D image is stored in one field and the depth map is stored in the other is likely to produce artifacts when the image is compressed using MPEG2 encoding.

MPEG2 encoding allows the video signal to be compressed using interlaced or progressive encoding. When interlaced encoding a 2D plus depth signal, the MPEG2 encoder compresses the difference between the 2D and depth map images in adjacent fields. When progressive encoding a 2D plus depth signal, the MPEG2 encoder compresses images comprised of the 2D and depth fields interleaved into alternate lines of a video frame. Interlaced encoding therefore requires high temporal compression quality, whereas progressive encoding requires high spatial compression quality.

Interlaced encoding produces acceptable 2D plus depth map image quality. However, the image quality is higher when the 2D plus depth map signal is progressive encoded.

Progressive MPEG2 encoding may introduce artifacts in the 2D plus depth map signal. When a line interleaved 2D plus depth map signal is converted to the 4:2:0 YUV colorspace used in MPEG2 compression, the half resolution chrominance component is calculated by averaging the chrominance components of the 2D signal and depth map signal. As the chrominance component of the depth map signal is zero, the chrominance component of the MPEG2 signal is equal to half of the 2D-chrominance component. When this signal is decompressed, the color saturation of the 2D signal is reduced compared to the original 2D signal.

This loss of color saturation may be reduced or eliminated by preprocessing the depth map signal. The chrominance component of the 2D signal is added to the luminance component of the depth map signal to create a modified depth map signal. The 2D signal is interlaced with the modified depth map and then compressed to MPEG2.

The chrominance component of the MPEG2 stream contains the chrominance component of the 2D signal averaged with it self, resulting in no chrominance loss to the 2D signal.

An alternative embodiment of this invention stores a 2D image in one field of a digital video image and an associated depth map in the other and digitally compresses the signal in interlaced mode.

In a further embodiment of this invention stores a 2D image in one field of a digital video image and an associated depth map in the other and digitally compress the signal in progressive mode, where the chrominance component of the 2D image has been copied into the chrominance component of the depth map prior to compression.

It should be noted that image compression techniques do not create artifacts or other problems in images created using the previously described n and (1-n) format, either with or without depth map data being stored in the chrominance channel. To minimize the crosstalk between the 2D and depth signals, the n to (1-n) transition should occur at a macroblock boundary (i.e., line number divisible by 16).

It will be appreciated by those skilled in the art that the foregoing techniques of storing a 2D image and associated depth map may be applied to any video medium including, although not limited to, digital and analogue video tape, DVD, DVD-R, CD, CD-ROM.

It will also be appreciated by those skilled in the art that these techniques of storing a 2D image and associated depth map may have other video compression techniques applied including, although not limited to, MPEG 1, MPEG 2, MPEG 4, DIVX.

The preceding disclosures enable the recording, storage and playback of 2D images and associated depth maps using standard video media and existing video compression techniques.

Whilst the method and system of the present invention has been summarized and explained by illustrative example it will be appreciated by those skilled in the art that many widely varying embodiments and applications are within the teaching and scope of the present invention, and that the examples presented herein are by way of illustration only and should not be construed as limiting the scope of this invention.

1. A method of encoding a 2D image with an associated depth map, said 2D image having a plurality of frames making up said 2D image and each frame having a odd and even field, wherein said method includes the step of recording said associated depth map in at least a portion of said odd or even field.

2. The method as claimed in claim 1, wherein said depth map is recorded in said odd field.

3. The method as claimed in claim 1, wherein said depth map is recorded in said even field.

4. The method as claimed in claim 2, further including the step of interpolating odd lines for each frame from image data stored in said even field.

5. The method as claimed in claim 3, further including the step of interpolating even lines for each frame from image data stored in said odd field.

6. The method as claimed in claim 1, wherein said depth map is recorded in a predetermined area of said odd and even field.

7. The method as claimed in claim 1, wherein said depth map is recorded in a fraction n of lines of said image.

8. The method as claimed in claim 7, wherein said depth map is at least partially recorded in each fields chrominance channel.

9. The method as claimed in claim 7, wherein fraction n is devisable by 16.

10. The method as claimed in claim 1, further including the step of digitally compressing said encoded signal in interlaced mode.

11. The method as claimed in claim 1, further including the step of digitally compressing said encoded signal in progressive mode.

12. The method as claimed in claim 1, further including the step of:
copying chrominance components of said 2D image into chrominance components of said depth map.

13. The method as claimed in claim 12, further including the step of digitally compressing said signal in progressive mode.

14. The method as claimed in claim 12, further including the step of digitally compressing said signal in interlaced mode.

15. An image including at least one frame, said frame including an odd field and an even field, wherein an associated depth map is recorded in at least a portion of said odd and/or even field.
